(19) United States
(12) Patent Application Publication
(10) Pub. No.: US 2017/0306276 A1
(43) Pub. Date: Oct. 26, 2017

(54) Method and Apparatus for Flash Freezing Drink Mixes

(71) Applicant: Curt Jones, Brentwood, TN (US)

(72) Inventor: Curt Jones, Brentwood, TN (US)

(21) Appl. No.: 15/138,583

(22) Filed: Apr. 26, 2016

(51) Int. Cl. C12G 3/06; A23L 3/375

(52) U.S. Cl. CPC C12G 3/06; A23L 3/375; A23V 2002/00

(57) ABSTRACT

A method for manufacturing a mixed drink confection, including combining one or more non-alcoholic ingredients with one or more alcoholic ingredients to form a liquid mix formulation, and cryogenically freezing the liquid mix formulation to form a plurality of cryogenically frozen beads of the liquid mix formulation by dripping the liquid mix formulation into a cryogenic liquid.

### FIELD OF THE INVENTION

The present invention relates to beverages and more particularly to an apparatus and method for creating flash frozen drink mixes.

### BACKGROUND OF THE INVENTION

There are a great variety of beverage choices available today for the ordinary consumer. However, even in view of this variety of choices, mixing different flavors together expands the choices even more. One area where this is especially true is in the field of alcoholic beverages. While there are many different types of distilled spirits, having a variety flavors, many people enjoy mixing these spirits with other flavors to concoct mixed drinks.

To simplify the making of mixed drinks, there are pre-mixed recipes of liquid “mixers” which a person can purchase. The mixers are typically non-alcoholic in nature and are formulated in the correct ratios such that they can be combined with one or more alcoholic beverages to make a mixed drink. However, many of these mixers require ice cubes, a blender, additional containers, and a power source to be readily available in order to make the mixed drink. Because of these requirements, the convenience of having re-formulated mixers is offset by another, new set of inconveniences.

Thus, there remains a need for a method and apparatus that allows making mixed drinks in a manner that is easier, simpler, and more convenient than presently known methods.

### SUMMARY OF THE INVENTION

Embodiments of the present invention relate to a method for manufacturing a mixed drink, including combining one or more non-alcoholic ingredients with one or more alcoholic ingredients to form a liquid mix formulation, and cryogenically freezing the liquid mix formulation to form a plurality of cryogenically frozen beads of the liquid mix formulation by dripping the liquid mix formulation into a cryogenic liquid.

Further embodiments of the present invention include a mixed drink, including frozen beads of a liquid mix formulation formed by dripping the liquid mix formulation into a cryogenic liquid, the liquid mix formulation including one or more non-alcoholic ingredients and one or more alcoholic ingredients.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts a flash freezing apparatus in accordance with the principles of the present invention.

FIG. 2 depicts a flowchart of an exemplary method for making flash frozen mixed drink beads in accordance with the principles of the present invention.

FIG. 3 depicts a flowchart of an exemplary method of making a mixed drink in accordance with the principles of the present invention.

### DETAILED DESCRIPTION OF THE PREFERRED EMBODIMENTS

“Alcoholic,” as used in this application, means containing alcohol. Alcohol as used herein refers to drinking alcohol, ethanol. For example, “mixed drinks” contain drinking alcohol and may be referred to as “alcoholic.”

“About,” as used in this application, means within plus or minus one at the last reported digit. For example, about 1.00 means 1.00±0.01 unit.

“Around,” when used to describe a unit or percentage, means within plus or minus one unit or plus or minus one percentage point.

For the purposes of this disclosure, “and” and “or” shall be construed as conjunctively or disjunctively, whichever provides the broadest disclosure in each instance of use of “and” and “or.”

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

As a result of the methods described herein, there are provided formulations of a frozen drink mix in the form of small particulate shapes that remain free-flowing during storage. The particulate shapes, generally referred to as “beads”, may have a generally spherical, spheroid shape but may also have an oblong, elliptical, oblate, tubular, or other slightly irregular shape. In addition to having an irregular overall shape, the surface of the particulate shape may also be either smooth or irregular (e.g. bumpy, pocked, etc.). On average, the particulate shapes will preferably have a diameter of about 5 mm or less but can also be larger such as between about 6 and about 10 mm. Particulate shapes having diameters outside these ranges are also contemplated. For non-spherical shapes which do not have a conventional diameter, the diameter is considered to be the diameter of the smallest sphere into which the particulate shape would fit.

It is desired that the particulate or beaded product is in a free-flowing format so that it is readily pourable. Free-flowing, as used herein, is a broad term which includes the ability of the product to flow as individual particulate shapes, with little or no clumping or sticking to each other, during such pouring. There may be slight sticking after a period of storage, but a light tap on the container may unstick the particulate shapes and allow them to be free flowing. The generally spherical shape helps contribute to the free-flowing, pourable product.

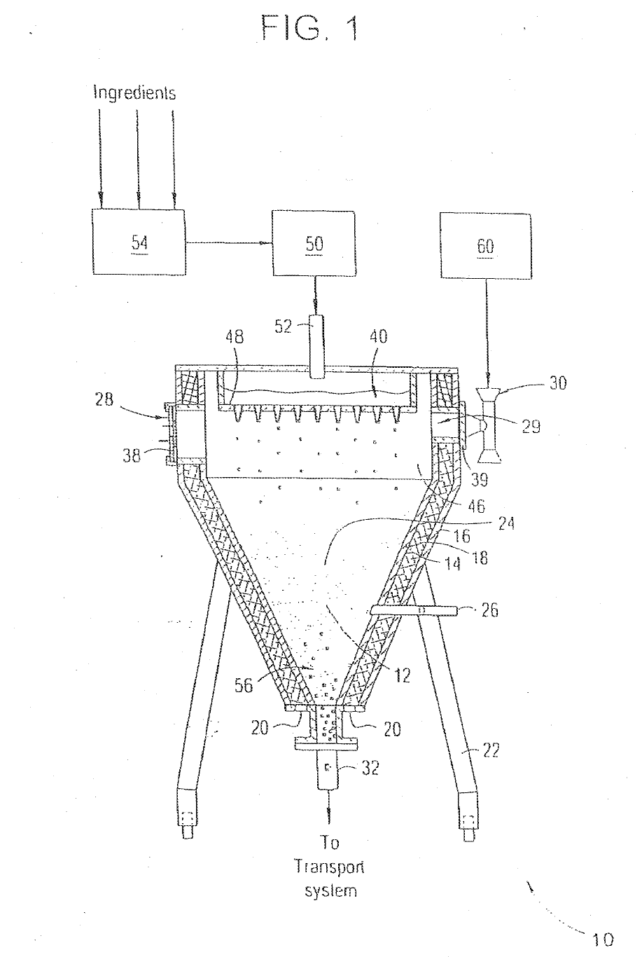

FIG. 1 shows a cryogenic processor constructed in accordance with the preferred embodiment of the present invention to produce free-flowing beads 56. The fundamental method utilized to produce the product is described in detail in U.S. Pat. No. 5,126,156, which is hereby incorporated by reference in its entirety.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 may be disposed between the inner shell 14 and outer shell 16 in order to increase the thermal efficiency of the chamber 12. However, a vacuum may be contained between inner shell 14 and outer shell 16. Vents 20 are also provided to ventilate the insulated area formed between the shells 14 and 16. The freezing chamber 12 may comprise a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48. The viscosity of the liquid composition as well as pressure applied by the pump (if any) can be selected so that the liquid passing through the feed tray does so at a desired rate and speed. For example, beads or pellets of uniform size may me generated or more irregular shaped beads or pellets may be generated. One way in which beads having an irregular shape and/or surface texture may be generated is to increase the speed at which the liquid composition passes through the feed tray 48.

In order to create uniformly sized particles or beads 56 of frozen product, uniformly sized droplets of liquid composition are required to be fed through gas diffusion chamber 46 to freezing chamber 12. The feed tray 48 is designed with feed assembly 40 that forms droplets of the desired character. The frozen product takes the form of beads that are formed when the droplets of liquid composition contact the refrigerant vapor in the gas diffusion chamber 46, and subsequently the liquid refrigerant 24 in the freezing chamber 12. After the beads 56 are formed, they fall or are mechanically directed to the bottom of chamber 12. A transport system connects to the bottom of chamber 12 at outlet 32 to carry the beads 56 to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow required.

Embodiments of the present invention contemplate the liquid composition described above being a liquid drink mixer that is then frozen into beads or pellets. In other words, the above cryogenic freezing apparatus is used to form frozen pellets which can be consumed or mixed with a base beverage to create a mixed drink. The pellets or beads can have a variety of different shapes and sizes. For example, a pellet size between about 4 and 10 mm in diameter is contemplated. However, larger and smaller sized pellets are also contemplated. As for texture, the pellets may be relatively uniform spherical beads with a relatively smooth surface. However, a rough surface texture and irregular shaped beads or pellets is beneficial as well. Thus, pellets resembling small asteroids or rocks are contemplated that have a nominal size of about 2 to 12 mm.

As for the base beverage, the typical beverage would be an alcoholic beverage such as a distilled spirit. However, embodiments of the present invention are not limited to only making alcoholic mixed drinks. Thus, the base beverage can include liquids such as coffees, teas, syrups, juices, wines, sodas, water, and combinations thereof in addition to alcoholic beverages.

The liquid composition that makes up the mixer can be any of a wide variety of flavors and components. For example, the liquid composition may include such things as margarita mix, apple martini mix, Piña Colada mix, mojito mix, sangrita mix, strawberry daiquiri mix, tomato juice, orange juice, fruit juice, vegetable juice, herbs, spices, essence oils, sugar, salt, and/or alcoholic liquids, such as vodka, rum, tequila, etc. Additionally, these elements can be concentrated by extracting a portion of their water volume. This concentrating of elements can be accomplished to change their flavor profile once reconstituted in a mixed drink as well as to create a formulation that is easier to freeze uniformly. Once the liquid composition is appropriately formulated, the next step is to freeze the fluid into the beads as described with respect to FIG. 1. These beads can then be transported to a packaging machine. The transporting of the beads can be accomplished in a variety of different ways such as by a feed screw, a moving conveyor belt, or gravity feed. The transporting means can also be cooled such that the beads remain cool while being transported to the packager.

Once the beads are packaged and delivered to a consumer such as an individual, a bar, a store, or a restaurant, the beads may be stored in a −40 degree Celsius freezer until they are used to make a beverage. Although the beads are frozen at cryogenic temperatures, there is no requirement that the cryogenically frozen non-alcoholic beads remain cooled to temperatures as low as −40 degrees Celsius but, instead, may be maintained at the standard operating temperatures of commercial and consumer freezers. However, due to the difficulty of freezing ethanol, the cryogenically frozen alcoholic beads may be maintained at −40 degrees Celsius or lower.

The ultimate use for the non-alcoholic frozen beads may be to use them to produce a beverage for consumption. However, the alcoholic beads may be consumed in frozen bead form or mixed with one or more liquids to produce a beverage for consumption. This can be accomplished in a variety of different ways without departing from the scope of the present invention. When a mixed drink is desired, the end consumer can remove a desired portion of the pellets from its package and combine that portion with an appropriate portion of a base beverage. Thus, without a blender or ice-cubes, a mixed drink can be made with ease, especially a “frozen” mixed drink such as a margarita or Piña Colada. Such mixed drinks can be made in a variety of sizes without departing from the scope of the present invention. Additionally, the use of the frozen beads to cool a mixed drink can eliminate the need for ice cubes and thereby result in a more flavorful drink that does not get watered down as the ice melts.

It is contemplated that a single pellet flavor would include all the components of a particular drink mixer. For example, each pellet of a margarita pelletized mixer would include all the non-alcohol flavors for that drink and may include alcohols, such as tequila, in some embodiments. However, in other embodiments, each pellet may have a single flavor component and different pellets are combined in appropriate proportions to make the pelletized mixer. Additionally, some components of a mixed drink may be omitted from the pelletized mixer. For example, a frozen pelletized mixer may omit the club soda flavor such that to create the mixed drink, the mixer is combined with alcohol and with club soda.

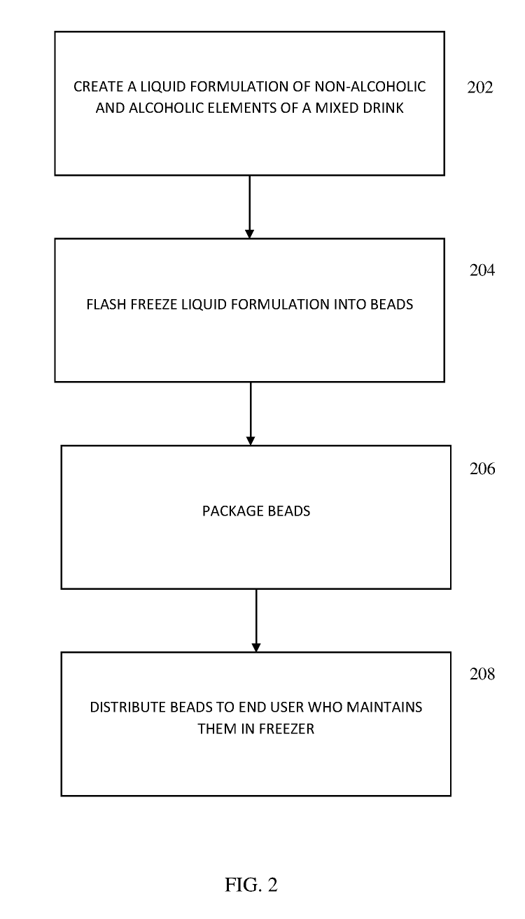

FIG. 2 depicts an exemplary flowchart outlining the steps described above for making flash frozen mixed drink beads in accordance with the principles of the present invention. In step 202, a liquid formulation is made that is to be flash frozen into beads. As discussed, the liquid formulation can include one or more liquid components as well as other granular or non-liquid elements that are suspended or dissolved within the liquid formulation. Also the liquid formulation can be a composite of many different flavors or it can be a single flavor formulation. Even for single-flavor formulations, other ingredients that do not add flavor but add body or different freezing characteristics can be included as well. The term “liquid” is intended to encompass a mixture that can flow whether using gravity or pressure. Thus semi-frozen mixes or mixes having a similar consistency are also contemplated within the scope of the present invention. Several large batches of different flavor mixes of liquid formulation, including margarita, Piña Colada, and strawberry daiquiri were prepared at 2, 4, 6, and 8 percent alcohol by mass. Preliminary experiments were also performed by freezing batches of liquid mix formulations of Piña Colada at 8.57, 9.12, and 9.39 and storing the resulting cryogenically frozen beads at −40 degrees Celsius. These mixes are described further herein.

In step 204 the liquid formulation is flash frozen into beads. The exemplary device of FIG. 1 is one method of creating such flash frozen beads but one of ordinary skill will recognize that other methods and techniques can be used as well. Once frozen, the beads can be packaged, in step 206. The beads can be packaged in a variety of ways such as single-flavored or multi-flavored beads being packaged in their own separate packaging; however other alternatives are contemplated. For example, a mix of single-flavor beads can be created by mixing in desired proportions the separate component flavor beads to create a drink mixer having a desired complex flavor. Also, multi-flavored beads can be mixed with single-flavor beads or other multi-flavored beads. Different flavor beads of different sizes can also be mixed together without departing from the scope of the present invention. The size of the packaging can vary as well. For example, individual drink mixers can be packaged separately or a larger size package can be used that is capable of making multiple mixed drinks.

In step 208, the packaged frozen drink mixer beads are distributed to an end user such as a grocery store, an individual, a restaurant, a bar or a commercial establishment. The beads are stored in a conventional freezer until used. In the larger packages, the appropriate amount of beads can be extracted for a desired number of drinks and the package returned to the freezer. In alternative embodiments, the commercial establishment may cryogenically freeze the beads in front of the customer and may package the beads in a cup. However, these beads may be allowed to warm to a safe temperature before consumption.

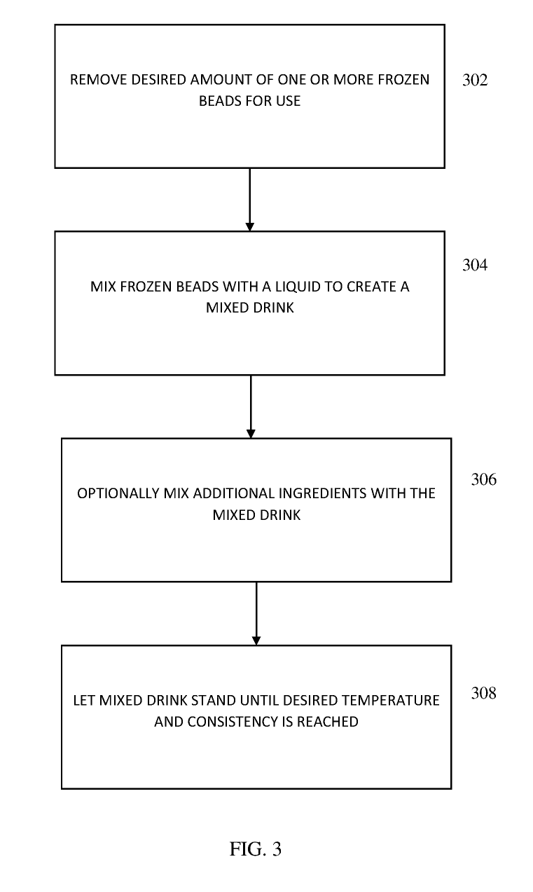

FIG. 3 depicts a flowchart of an exemplary method for making a mixed drink in accordance with the principles of the present invention. In step 302, a user removes a desired amount of frozen beads for making a mixed drink. For example, the user could simply remove the desired amount of a multi-flavored bead or remove a desired amount of a bead mix that is substantially a homogenous mixture of one or more differently flavored beads. Alternatively, the user could mix and match different flavored beads to concoct a mixed drink having a desired flavor.

In step 304, the non-alcoholic beads are mixed with one or more alcohol components to create a mixed drink. However, the alcoholic beads may not necessarily be mixed with an alcohol component, but may be mixed with a non-alcoholic component to form a mixed drink. Optionally, in step 306, additional non-alcoholic ingredients can also be added to modify the mixed drink formed by either alcoholic or non-alcoholic beads. For example, fresh squeezed lime juice could be added in order to capture a fresh citrus flavor. Also, ice cream or similar frozen foods can be added as well. The actual mixing of the drink can be accomplished using conventional mixing methods appropriate for each type of drink that is being created. Some drinks are vigorously shaken, while others are gently stirred.

In step 308, the mixed drink is permitted to rest until the desired consistency and temperature of the drink is achieved. Some drinks benefit from being smooth and homogenous in texture; others, however, are better served while slushy or semi-frozen. Embodiments of the present invention also contemplate relatively large applications of mixed drinks. For example, at a gathering with dozens or hundreds of people, margaritas might be appropriate. Rather than making each drink individually or making a large mix and waiting for it to freeze, the frozen beads of the present invention can be utilized. For example, an appropriate amount of drink mixer beads can be added to a desired amount of alcohol to make a mix that can be used for multiple individual drinks. If this mix is kept in a container that can maintain the drinks slushy texture, then a fresh margarita (for example) can be easily and quickly poured for numerous people across a relatively long span of time such as an hour or more.

In some embodiments of the present invention steps 302 through 308 may be performed by a bartender or by a customer at a bar. Of course, the alcoholic frozen beads may be transported to the bar after cryogenic freezing. These frozen beads may be transported to the bar at −40 degrees Celsius. In additional embodiments, the liquid mix formulation for each respective flavor may be transported to the bar. The liquid mix formulation may then be dripped into cryogenic liquid at the bar before serving. Of course, the temperature of liquid nitrogen may be below −196 degrees Celsius, and therefore the resulting beads may be dangerous to consume until allowed to warm. For example, the beads may be warmed to −40 degrees Celsius before serving bar patrons.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.

### EXAMPLES

Alcohol may be included in the liquid mix formulation before dripping the liquid mix formulation through feed tray 48 into the refrigerant 24 to form frozen beads. Due to the freezing point depression effect caused by additional ingredients, such as sugar, when mixed with water combined with the freezing point depression of ethanol when mixed with water, the ability to keep alcoholic frozen beads frozen at −40 degrees Celsius was unexpected. Flavor mixes of margarita, Piña Colada, and strawberry daiquiri were each prepared having 0, 2, 4, 6, and 8 percent alcohol by mass. Piña Colada was also prepared at 8.67, 9.12, and 9.39 percent alcohol by mass. Each flavored mix was then dripped into liquid nitrogen to form cryogenically frozen beads of each respective flavor. Each mix of each flavor was then observed in storage in respective ziplock bags at −40 degrees Celsius over a two month period. In fact, at least three cups of each batch of each respective flavor and each respective alcohol content was stored in respective ziplock bags.

The respective non-alcoholic mixes retained their rigid bead form throughout the duration of the two month period. The majority of the beads of the respective flavor mixes containing up to about 8.8 percent alcohol by mass retained their beaded shape. However, as the alcohol content increased, the frozen beads softened more rapidly. It was typically found that alcoholic beads up to about 8.8 percent alcohol could be stored for up to six weeks at −40 degrees Celsius without significant slush formation. For example, Piña Colada and strawberry daiquiri could be stored at −40 degrees Celsius for approximately six weeks without significant alcohol sweating and slushing of the respective bags of beads. However, the margarita cryogenically frozen beads were found to sweat alcohol and slush after one month of storage. Therefore, the margarita beads may be served at storage of one month or less in the −40 degrees Celsius freezer. Accordingly, cryogenically frozen beads containing rum may be stored at −40 degrees Celsius for up to six weeks before serving, and cryogenically frozen beads containing tequila may be stored at −40 degrees Celsius for up to one month before serving.

In correlation with the discovered pattern, the Piña Colada batches of 9.12, and 9.39 percent alcohol beads were found to remain in a pliable semi frozen bead state for approximately seven days before the beads coalesced into a slush with separated pooled alcohol. In fact, these respective batches began to “sweat” alcohol, wherein a small volume of liquid ethanol escaped from the beads and formed liquid droplets on the inside of the ziplock bag within a few days. However, the majority of beads remained in a soft, frozen beaded state. A minority of the beads were squished into a slush by the weight of other beads within the same ziplock bag. Slight alcohol sweating occurred by the end of one week, after which alcohol sweating seemed to pool around the semi-frozen slush of remaining ingredients. The resulting product, after storage greater than one week was no longer visually appealing and may have to be stirred before serving to reach a uniform consistency. Therefore, it was found that Piña Colada having an alcohol content of 9.0 percent alcohol by mass or higher should be served at or before one week of storage at −40 degrees Celsius. It is expected that cryogenically frozen beads of margarita and strawberry daiquiri must also be served at or before one week of storage at −40 degrees Celsius as well.

Taste tests were also performed. It was found that the preferred density, mouthfeel, flavoring, and alcohol burn was obtained at 8.76 percent for each flavor for a majority of taste testers. However, a minority of women preferred the properties of the respective flavors at 6 percent alcohol by mass. Additionally, a minority of men preferred the properties of Piña Colada at 9.12 percent alcohol by mass.

Therefore, the discovery of the present invention may involve the interplay of two different considerations. First, it was unknown whether alcoholic mixtures containing sugar and other ingredients would remain frozen at −40 degrees Celsius after cryogenic freezing. Second, it was unknown whether the recipes used would provide a desirable taste, density, mouthfeel, flavoring, and alcohol burn. Unexpectedly, each respective flavor formulation remained frozen at about 8.76 percent alcohol by mass and the majority of taste testers preferred each respective formulation at about 8.76 percent alcohol by mass.

### Example 1: Preparation of Piña Colada

A Piña Colada liquid mix formulation may be prepared using at least one of the following ingredients: water, sucrose, cream of coconut, and pineapple. For example, 1412 grams (g) of water, 371 g sucrose, 375 g cream of coconut, and 188 g pineapple may be mixed to form 2346 g Piña Colada liquid mix formulation. Accordingly, the Piña Colada liquid mix formulation may be combined with rum to form an alcoholic Piña Colada liquid mix formulation.

For example, multiple Piña Colada liquid mix formulations were prepared using Meijer spring water, Thai Kitchen coconut cream, Psst Granulated Sugar, Old Orchard pineapple concentrate, and Bacardi Superior White 80 proof rum.

The method of preparation of the Piña Colada liquid mix formulation was as follows: Using a graduated cylinder, water was measured and then poured into a mixing bowl. Using a balance, granulated sucrose was weighed and then poured into a mixing bowl. The water and sucrose was stirred until a majority of the sucrose had dissolved. The coconut cream was placed into a small mixing container and stirred until homogeneity was achieved. The coconut cream was then placed in the mixing bowl. The contents of the mixing bowl was stirred vigorously to prevent clumping of the coconut cream. The pineapple concentrate was added to the mixing bowl, while stirring to maintain homogeneity. The mixture was then added to a metal pot and heated at a medium setting until the mixture reached approximately 88 degrees Celsius (190 degrees Fahrenheit). The mixture was stirred while heating to prevent burning. After achieving the 88° C., the pot was allowed to cool to room temperature. The rum was then added to the mixture and the mixture stirred until homogenous. The liquid mix formulation was then poured through the dripping apparatus into a container of liquid nitrogen. However, the liquid mix formulation was poured slowly, such that the liquid mix formulate dripped into the liquid nitrogen rather than poured into the liquid nitrogen as a stream. The container of liquid nitrogen was then strained using a colander to remove the cryogenically frozen beads from the liquid nitrogen. The cryogenically frozen beads were then removed from the colander and separated into gallon Ziplock deep freezer bags. Each Ziplock bag was filled to approximately half volume. Each bag was then placed in a deep freezer maintained at approximately −40° C. The liquid nitrogen was then returned to the container for the next batch of frozen beads

A non-alcoholic Piña Colada liquid mix formulation was prepared by mixing 1412 grams water, 371 g sucrose, 375 g coconut cream, and 188 g pineapple concentrate. The non-alcoholic Piña Colada liquid mix formulation was frozen into beads and stored in the freezer as a control. The non-alcoholic Piña Colada liquid mix formulation was also mixed with rum and then frozen into beads and stored.

For example, a two percent ethanol by mass Piña Colada liquid mix formulation was prepared by mixing 2346 g non-alcoholic Piña Colada liquid mix formulation with 145 g of 80 proof rum (50 g of ethanol). A four percent ethanol by mass Piña Colada liquid mix formulation was prepared by mixing 2346 g of non-alcoholic Piña Colada liquid mix formulation with 309 g of 80 proof rum (106 g of ethanol). A six percent ethanol by mass Piña Colada liquid mix formulation was prepared by mixing 2346 g of non-alcoholic Piña Colada liquid mix formulation with 495 g of 80 proof rum (170 g of ethanol). An eight percent ethanol by mass Piña Colada liquid mix formulation was prepared by mixing 2346 g of non-alcoholic Piña Colada liquid mix formulation with 711 g of 80 proof rum (245 g of ethanol).

### Example 2: Preparation of Margarita

A margarita liquid mix formulation may be prepared using at least one of the following ingredients: water, sucrose, lemonade, orange juice, limeade, pineapple, maltodextrin, and tequila. For example, 1318 grams (g) of water, 339 g sucrose, 100 g lemonade, 22 g orange juice, 11 g limeade, 38 g pineapple, and 76 g of maltodextrin may be mixed to form 1904 g margarita liquid mix formulation. Accordingly, the margarita mix may be combined with tequila to form an alcoholic margarita liquid mix formulation. The lemonade (e.g. lemonade concentrate) may comprise concentrated lemon juice, such as the cloudy 400 GPL concentrated lemon juice provided by Citromax. The limeade (e.g. limeade concentrate) may comprise concentrated lime juice, such as the cloudy Persian lime juice supplied by Citrofrut.

For example, the margarita liquid mix formulation was prepared using Meijer spring water, Psst granulated sugar, lemonade concentrate, Now Foods carbogain (maltodextrin), Old Orchard pineapple concentrate, Old Orchard orange concentrate, Limeade concentrate, and Montezuma Gold 80 proof tequila.

The method of preparation of the margarita liquid mix formulation was as follows: Using a graduated cylinder, water was measured and then poured into a mixing bowl. Using a balance, granulated sucrose was weighed and then poured into a mixing bowl. The water and sucrose was stirred until a majority of the sucrose had dissolved. Maltodextrin was then added to the mixing bowl and stirred vigorously to prevent clumping. The lemonade, pineapple, orange, and limeade concentrates were added to the mixing bowl. The mixture was stirred vigorously to achieve homogeneity. The mixture was then added to a metal pot and heated at a medium setting until the mixture reached approximately 88 degrees Celsius (190 degrees Fahrenheit). The mixture was stirred while heating to prevent burning. After achieving the 88° C., the pot was allowed to cool to room temperature. The tequila was then added to the mixture and the mixture stirred until homogenous. The liquid mix formulation was then poured through the dripping apparatus into a container of liquid nitrogen. However, the liquid mix formulation was poured slowly, such that the liquid mix formulate dripped into the liquid nitrogen rather than poured into the liquid nitrogen as a stream. The container of liquid nitrogen was then strained using a colander to remove the cryogenically frozen beads from the liquid nitrogen. The cryogenically frozen beads were then removed from the colander and separated into gallon Ziplock deep freezer bags. Each Ziplock bag was filled to approximately half volume. Each bag was then placed in a deep freezer maintained at approximately −40° C. The liquid nitrogen was then returned to the container for the next batch of frozen beads.

A non-alcoholic margarita liquid mix formulation was prepared by mixing 1318 grams water, 339 g sucrose, 100 g lemonade, 22 g orange concentrate, 11 g limeade, 38 g pineapple concentrate, and 76 g maltodextrin. The non-alcoholic margarita liquid mix formulation was frozen into beads and stored in the freezer as a control. The non-alcoholic margarita liquid mix formulation was also mixed with tequila and then frozen into beads and stored.

For example, a two percent ethanol by mass margarita liquid mix formulation was prepared by mixing 1904 g non-alcoholic margarita liquid mix formulation with 117 g of 80 proof tequila (40 g ethanol). A four percent ethanol by mass margarita liquid mix formulation was prepared by mixing 1904 g of non-alcoholic margarita liquid mix formulation with 250 g of 80 proof tequila (86 g ethanol). A six percent ethanol by mass margarita liquid mix formulation was prepared by mixing 1904 g of non-alcoholic margarita liquid mix formulation with 403 g of 80 proof tequila (139 g ethanol). An eight percent ethanol by mass margarita liquid mix formulation was prepared by mixing 1904 g of non-alcoholic margarita liquid mix formulation with 576 g of 80 proof tequila (198 g ethanol).

### Example 3: Preparation of Strawberry Daiquiri

A strawberry daiquiri liquid mix formulation may be prepared using at least one of the following ingredients: water, sucrose, strawberry puree, maltodextrin, lemonade, and limeade. For example, 1210 grams (g) of water, 325 g sucrose, 408 g strawberry puree, 82 g maltodextrin, 8 g lemonade, and 8 g limeade may be mixed to form 2041 g strawberry daiquiri liquid mix formulation. The strawberry puree may consist of puree grade or better strawberries prepared from sound, properly ripened fresh fruit, which has been stemmed, sorted, washed, and sanitized. For example, the strawberry puree may be the Totem Strawberry Seedless Puree, Code: SB011, provided by Transpacific Food, Inc. Accordingly, the strawberry daiquiri liquid mix formulation may be combined with rum to form an alcoholic strawberry daiquiri liquid mix formulation.

For example, the strawberry daiquiri liquid mix formulation was prepared using Meijer spring water, strawberry puree, Psst granulated sucrose, Now Foods carbogain (maltodextrin), Lemonade concentrate, Limeade concentrate, and Bacardi Superior White 80 proof rum.

The method of preparation of the strawberry daiquiri liquid mix formulation was as follows: Using a graduated cylinder, water was measured and then poured into a mixing bowl. Using a balance, granulated sucrose was weighed and then poured into a mixing bowl. The water and sucrose was stirred until a majority of the sucrose had dissolved. Maltodextrin was then added to the mixing bowl and stirred vigorously to prevent clumping. The strawberry puree, lemonade, and limeade concentrates were added to the mixing bowl. The mixture was stirred vigorously to achieve homogeneity. The mixture was then added to a metal pot and heated at a medium setting until the mixture reached approximately 88 degrees Celsius (190 degrees Fahrenheit). The mixture was stirred while heating to prevent burning. After achieving the 88° C., the pot was allowed to cool to room temperature. The rum was then added to the mixture and the mixture stirred until homogenous. The liquid mix formulation was then poured through the dripping apparatus into a container of liquid nitrogen. However, the liquid mix formulation was poured slowly, such that the liquid mix formulate dripped into the liquid nitrogen rather than poured into the liquid nitrogen as a stream. The container of liquid nitrogen was then strained using a colander to remove the cryogenically frozen beads from the liquid nitrogen. The cryogenically frozen beads were then removed from the colander and separated into gallon Ziplock deep freezer bags. Each Ziplock bag was filled to approximately half volume. Each bag was then placed in a deep freezer maintained at approximately −40° C. The liquid nitrogen was then returned to the container for the next batch of frozen beads.

A non-alcoholic strawberry daiquiri liquid mix formulation was prepared by mixing 1210 grams water, 325 g sucrose, 408 g strawberry puree, 82 g maltodextrin, 8 g lemonade, and 8 g limeade. The non-alcoholic strawberry daiquiri liquid mix formulation was frozen into beads and stored in the freezer as a control. The non-alcoholic strawberry daiquiri liquid mix formulation was mixed with rum and then frozen into beads and stored.

For example, a two percent ethanol by mass strawberry daiquiri liquid mix formulation was prepared by mixing 2041 g non-alcoholic strawberry daiquiri liquid mix formulation with 126 g of 80 proof rum (43 g ethanol). A four percent ethanol by mass strawberry daiquiri liquid mix formulation was prepared by mixing 2041 g of non-alcoholic strawberry daiquiri liquid mix formulation with 268 g of 80 proof rum (92 g ethanol). A six percent ethanol by mass strawberry daiquiri liquid mix formulation was prepared by mixing 2041 g of non-alcoholic strawberry daiquiri liquid mix formulation with 431 g of 80 proof rum (148 g ethanol). An eight percent ethanol by mass strawberry daiquiri liquid mix formulation was prepared by mixing 2401 g of non-alcoholic strawberry daiquiri liquid mix formulation with 618 g of 80 proof rum (213 g of ethanol).

The respective flavors of liquid mix formulations of 0%, 2%, 4%, 6%, and 8% ethanol by mass were then dripped into liquid nitrogen in a repeat trial. The respective sets of cryogenically frozen beads were then placed in ziplock bags and stored in a −40 degree Celsius freezer and observed over two months.

The respective batches of Piña Colada and Strawberry Daiquiri prepared at 8% ethanol by mass or less retained their beaded shape for up to six weeks when stored at −40 degrees Celsius.

However, the margarita cryogenically frozen beads of 8% or less ethanol by mass stored well for up to and including one month at −40 degrees Celsius. These cryogenically frozen beads retained sufficient rigidity to retain their bead-like shape without significant alcohol sweating until one month of storage.

It was found from the preliminary tests that Piña Colada frozen beads above 9.12% ethanol by mass began to melt relatively quickly and may only keep for one week or less at −40 degrees Celsius. After one week, Piña Colada beads above 9.12% began to slush and the alcohol separated out. As the alcohol began to melt, the alcohol separated from the beads and pooled. The beads also began to congeal into a slush separate from the alcohol. However, the Piña Colada beads at 8.76% prepared in the preliminary test retained their frozen beaded form until about six weeks of storage at −40 degrees Celsius. Based on the similarity of results achieved, it is expected that 8.76% strawberry daiquiri would retain frozen for up to six weeks of storage at −40 degrees Celsius as well.

Regarding each batch, the respective beads remain free-flowing, but may begin to momentarily stick when slowly poured near one month of storage. After the respective storage thresholds at −40 degrees Celsius, the respective beads began to congeal into a slush and ethanol began to separate. Although the 8% ethanol beads were not as hard as the 0% ethanol beads, taste tests continued to provide positive feedback regarding the appearance, mouthfeel, alcohol burn, flavor, and texture of the 8% beads.

1. A method of manufacturing a mixed drink confection, comprising:
combining one or more non-alcoholic ingredients with one or more alcohol ingredients to form a liquid mix formulation comprising from 1.0 percent alcohol by mass to about 8.7 percent alcohol by mass, the liquid mix formulation further comprising one of a Piña Colada liquid mix, a strawberry daiquiri liquid mix, or a margarita liquid mix;
cryogenically freezing the liquid mix formulation to form a plurality of cryogenically frozen beads of the liquid mix formulation by dripping the liquid mix formulation into a cryogenic liquid;
storing the cryogenically frozen beads at up to around −40 degrees Celsius; and
serving the cryogenically frozen beads at or within six weeks of storing the cryogenically frozen beads.

2. A method of manufacturing a mixed drink confection, comprising:
combining one or more non-alcoholic ingredients with one or more alcohol ingredients to form a liquid mix formulation comprising from about 9.1 percent to about 9.5 percent alcohol by mass, the liquid mix formulation further comprising one of a Ma Colada liquid mix formulation, a strawberry daiquiri liquid mix formulation, or a margarita liquid mix formulation;
cryogenically freezing the liquid mix formulation to form a plurality of cryogenically frozen beads of the liquid mix formulation by dripping the liquid mix formulation into a cryogenic liquid;
storing the cryogenically frozen beads at up to around −40 degrees Celsius; and
serving the cryogenically frozen beads at or within one week of storing the cryogenically frozen beads.

3.-5. (canceled)

6. The method of claim 1, further comprising:
combining the plurality of cryogenically frozen beads with a first liquid to form a mixed drink.

7. The method of claim 6, wherein the first liquid is alcoholic.

8. The method of claim 6, further comprising:
combining one or more ingredients to form an additional liquid mix formulation;
cryogenically freezing the additional liquid mix formulation to form an additional plurality of cryogenically frozen beads of the additional liquid mix formulation by dripping the additional liquid mix formulation into the cryogenic liquid; and
combining the additional plurality of cryogenically frozen beads with the mixed drink,
wherein the additional plurality of cryogenically frozen beads has a different flavor than the plurality of cryogenically frozen beads.

9. The method of claim 8, wherein the additional liquid mix formulation is alcoholic.

10. The method of claim 8, wherein the additional liquid mix formulation comprises about 1.0 percent alcohol by mass to about 8.7 percent alcohol by mass.

11.-12. (canceled)

13. A mixed drink, comprising:
frozen beads of a liquid mix formulation mixed with a beverage base,
wherein the frozen beads are formed by dripping the liquid mix formulation into a cryogenic liquid, the liquid mix formulation comprising one or more non-alcoholic ingredients and one or more alcoholic ingredients.

14. (canceled)

15. The mixed drink of claim 13, wherein the liquid mix formulation comprises about 8.7 percent alcohol by mass.

16. (canceled)

17. The mixed drink of claim 13, further comprising:
additional frozen beads of an additional liquid mix formulation formed by dripping the additional liquid mix formulation into a cryogenic liquid, the additional liquid mix formulation comprising one or more non-alcoholic ingredients,
wherein the additional frozen beads are a different flavor than the frozen beads.

18. The mixed drink of claim 17, wherein the additional liquid mix formulation comprises one or more alcoholic ingredients.

19. (canceled)

20. (canceled)

21. The mixed drink of claim 13,
wherein the frozen beads further comprise one of a Piña Colada liquid mix, a strawberry daiquiri liquid mix, or a margarita liquid mix.

22. The mixed drink of claim 21,
wherein the frozen beads further comprise from 1% alcohol by mass to about 8.7% alcohol by mass; and
wherein the frozen beads were stored in a freezer at up to around −40 degrees Celsius for up to six weeks.

22. The mixed drink of claim 21,
wherein the frozen beads comprise from about 9.1% to about 9.5% alcohol by mass; and
wherein the frozen were stored in a freezer at up to around −40 degrees Celsius for up to one week.

23. The method of claim 1, wherein the liquid mix formulation comprises about 8.7 percent alcohol by mass.

24. The method of claim 1, wherein the liquid mix formulation comprises between 1.0 percent and 5.9 percent alcohol by mass.

25. The method of claim 2, further comprising:
combining the plurality of cryogenically frozen beads with a first liquid to form a mixed drink.

26. The method of claim 25, wherein the first liquid is alcoholic.

27. The method of claim 25, further comprising:
combining one or more ingredients to form an additional liquid mix formulation;
cryogenically freezing the additional liquid mix formulation to form an additional plurality of cryogenically frozen beads of the additional liquid mix formulation by dripping the additional liquid mix formulation into the cryogenic liquid; and
combining the additional plurality of cryogenically frozen beads with the mixed drink,
wherein the additional plurality of cryogenically frozen beads has a different flavor than the plurality of cryogenically frozen beads.

28. The method of claim 27, wherein the additional liquid mix formulation is alcoholic.
